(19) United States
(12) Patent Application Publication
(10) Pub. No.: US 2011/0069673 A1
(43) Pub. Date: Mar. 24, 2011

(54) LOCAL ROUTING OF VOICE CALLS BY A FEMTO GATEWAY

(75) Inventors: Anand OSWAL, Pune (IN); Anal SRIVASTAVA, Pune (IN); Mahavir KARNAVAT, Pune (IN); Sandeep GAUTAM, Pune (IN)

(73) Assignee: STARENT NETWORKS, CORP, Tewksbury, MA (US)

(21) Appl. No.: 12/563,898

(22) Filed: Sep. 21, 2009

(51) Int. Cl. H04W 36/00

(52) U.S. Cl. 370/331

(57) ABSTRACT

A femto gateway enables local routing of voice calls for users communicating through the same femto gateway, without passing through a mobile switching center. Local routing reduces costly switching of calls, and can provide better quality of service and more innovative service plans to subscribers.

### BACKGROUND

Wireless networks are telecommunications networks that use radio waves to carry information from one node in the network to one or more receiving nodes in the network. Cellular telephony is characterized by the use of radio cells that provide radio coverage for a geographic area, with multiple cells arranged to provide contiguous radio coverage over a larger area. Wired communication can also be used in portions of a wireless network, such as between cells or access points.

The first generation of wireless telephone technology used analog mobile phones in which analog information signals were modulated and transmitted. In second generation (2G) systems, digital information signals were used to modulate a carrier. These 2G technologies used time division multiplex access (TDMA) technology for GSM systems, or code division multiple access (CDMA) technologies for IS-95 systems to distinguish multiple users. Such networks were further upgraded to handle higher-speed packet data using GPRS/EDGE and then HSPA, and CDMA 1x-EVDO in networks referred to as 2.5G and 3G networks. The next evolution is 4G technology, which is referred to as long term evolution-system architecture evolution (LTE-SAE) and uses orthogonal frequency division multiple access (OFDMA) technology. Other wireless protocols have also developed including WiFi (an implementation of various IEEE 802.11 protocols), WiMAX (an implementation of IEEE 802.16), and HiperMAN, which is based on an ETSI alternative to IEEE 802.16.

Wireless communication technologies are used in connection with many applications, including, for example, satellite communications systems, portable digital assistants (PDAs), laptop computers, and mobile devices (e.g., cellular telephones, user equipment). Users of such applications can connect to a network (e.g., the Internet) as long as the user is within range of such a wireless communication technology. The range of the wireless communication technology can vary depending on the deployment. A macro cell transceiver is typically used by service providers to provide coverage over about a five kilometer distance. A pico cell transceiver can provide coverage over about a half kilometer distance, and a femto cell transceiver can provide coverage over a 50-200 meter distance. A femto cell transceiver is similar in coverage to a WiFi (WLAN) access point and can be used to provide network access over a short range.

### SUMMARY

A femto gateway (GW) can be used to connect a user through a femto cell to a mobile switching center (MSC), and then to other users. A single gateway can serve a number of femto cells, which can serve a campus or a community. If all calls within such a campus or community have go to a MSC for switching, considerable core network resources can be utilized.

As disclosed here, a femto GW can enable local routing of voice calls at the femto gateway (GW), thereby reducing the amount of costly switching of calls required at the MSC, and reducing core network traffic. Local routing can also lead to better quality of service and more innovative service plans can be provided to subscribers; for example, there can be zero cost of calls within a closed subscriber group (CSG) or in a particular region. By not reserving costly bearer towards the MSC from the femto GW or adding the overhead of switching at the MSC for these local calls, one can provide cheaper push-to-talk/local exchange functionality.

Other features and advantages will become apparent from the following detailed description, drawing, and claims

### BRIEF DESCRIPTION OF THE DRAWINGS

FIG. 1 is a block diagram of a femto cell system; and

FIG. 2 is a call flow diagram of local routing at a femto gateway.

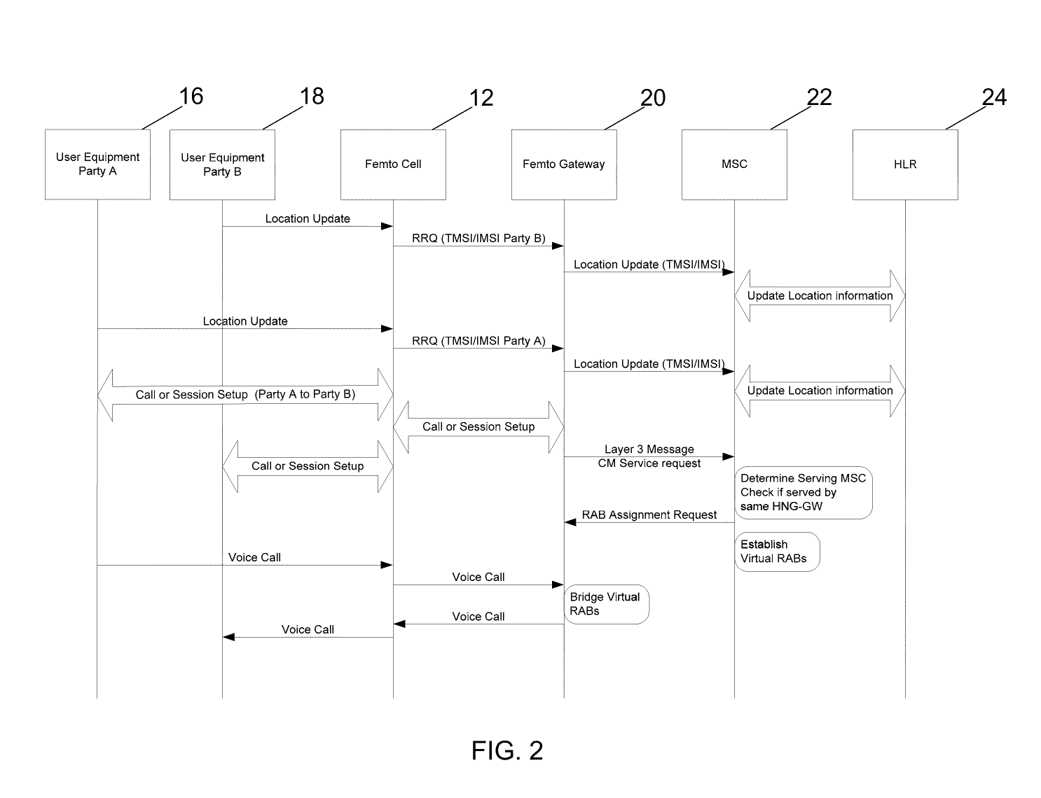

### DESCRIPTION

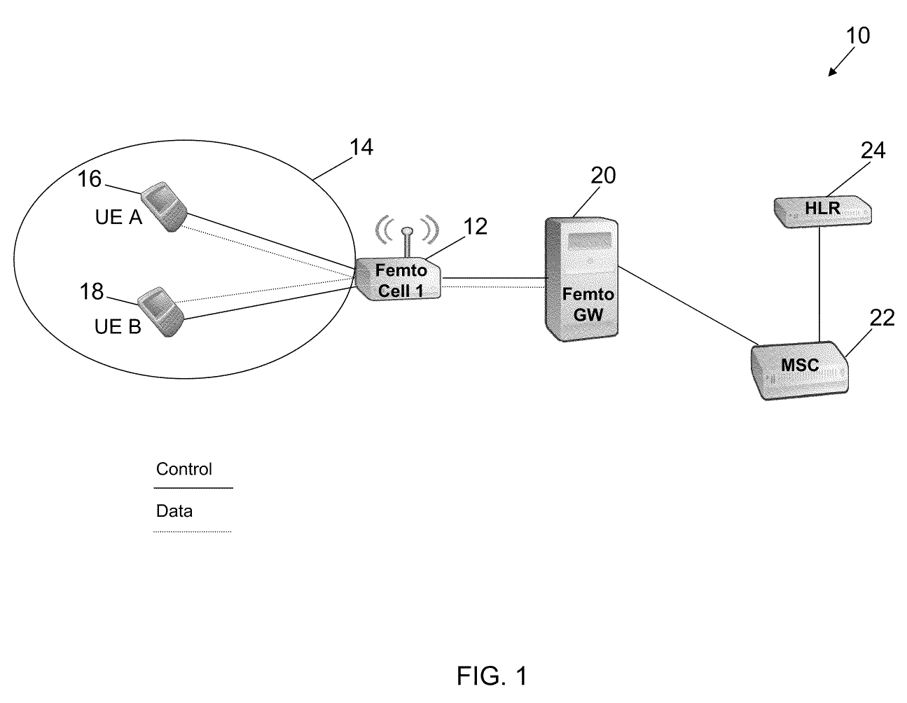

Referring to FIG. 1, in a femto cell system 10, a femto cell 12 communicates with user equipment (UE) in a femto cell coverage area represented by region 14. Within region 14 are shown two devices (although there could be many more) which would typically be mobile and are referred to as user equipment (UE) A 16 and UE B 18. Femto cell 12 communicates with a femto gateway (femto GW) 20, which communicates with a mobile switching center (MSC) 22. The MSC can be coupled to a home location register (HLR) 24, which is a database of user (subscriber) information such as customer profiles. The HLR can include account information, account status, user preferences, features, and any other applicable data for the system.

Many femto cells can communicate with one femto gateway, so the one gateway could serve a household or small office, but with a number of cells, could serve a wider area, such as a college or university campus, a corporate campus, a neighborhood, or a community.

A femto cell (also sometimes referred to as a femto access point) is a form of base transceiver station (BTS). Combined with gateway-supporting femto cell functionality, the femto cell acts as a base station system/radio network controller (BSS/RNC) for a microcellular environment. For CDMA2000, the combination acts as a packet control function (PCF). The femto gateway provides a proxy functionality. When acting as a RNC, for example, the femto GW hides the femto cell from the core network and handles the processing to remove complexity from the core network having to communicate with many femto cells. Where applicable, the gateway also provides seamless mobility between macro cellular networks and femto cellular networks.

A femto cell connects to the gateway over a fixed broadband transport using a security association with the gateway. The security association between the femto cell and the gateway is based on IPSec. IKEv2 is used as an IPSec protocol. In some embodiments, all the user plane and management plane traffic between the femto cell and the gateway is encrypted and integrity protected. The femto GW creates a security association with the femto cell to provide a secure transport of signaling, bearer and management plane traffic.

The femto GW also provides a radio access network (RAN) aggregation function by including a signaling concentrator function. The signaling concentrator abstracts all the femto cells as a single radio network controller (RNC) to a public land mobile network core network (PLMN CN). The femto cell and femto GW are further described in U.S. Patent Publication 2009/0156213, entitled “Interworking Gateway for Mobile Nodes,” which is hereby incorporated by reference herein in its entirety.

An interworking function can be used to implement a policy and charging enforcement function (PCEF) to provide policy and charging control of subscriber service data flows. The gateway gets the policy and charging control (PCC) rules from a policy and charging rules function (PCRF). The gateway also provides authorized QoS to the flows.

Operation of a system is described in an example in which Party A calls Party B. UE B 18 (also referred to as Party B) makes a location update when it enters region 14 of femto cell 12. Femto GW 20 gets a UE registration request from femto cell 12 that contains an international mobile subscriber identity/temporary mobile subscriber identity (IMSI/TMSI) of UE B. The MSC gets the TMSI/IMSI of UE B 18 from the location update from the femto GW and can interact with the HLR to update the location information for UE B.

UE A 16 (Party A) also makes a location update when entering region 14 of femto cell 12. Femto GW 20 gets a UE registration request from the femto cell 12 that contains the IMSI/TMSI of UE A. The MSC gets the TMSI/IMSI of the calling party A from the location update and interacts with the HLR to update the location information of the calling Party A.

In the example here, Party A initiates a call to Party B. Femto GW 20 sends a Layer-3 message containing a connection management (CM) service request to MSC 22. MSC 22 determines a serving MSC/VLR of called Party B either by using information in a visitor location register (VLR), or by looking up the information.

Party A and Party B are served by the same femto GW, so in the most typical case, they would also be served by the same MSC. This is almost always true when Party A and Party B communicate with the same femto cell 12. When the MSC discovers that the VLR is within the purview of a particular MSC, it knows that local (intra-MSC) routing needs to be done. The MSC has an incremental step of checking if the RNC ID of the VLR/LAC is that of femto GW 20.

If at MSC 22, it is determined that both the called Party B and calling Party A are being served by the same femto GW 20 (regardless of whether they are served by the same femto cell), then when issuing a radio access bearer (RAB) assignment request, the MSC establishes virtual RABs. These RABs are not asynchronous transfer mode (ATM) radio bearers between the MSC and the femto GW, but originate and terminate at the femto GW itself. Two of these virtual RABs are assigned and later connected at the femto GW, instead of using the actual switch fabric at MSC 22. As the RABs are real-time protocol (RTP) flows switching can be performed in software at the femto GW.

Once a voice circuit is thus established, RTP data can flow between Party A and Party B, routed at femto GW 20, without any involvement of MSC 22 and without requiring RTP-ATM conversions at the femto GW or switching of voice circuits on MSC 22. This process can involve useful cost savings, especially if a traditional ATM-based MSC is involved. As MSC is involved in the control plane, no extra functionality is required at the HNB-GW.

If Party B were located in the macro network and not coupled to the same femto GW as Party A, MSC would treats the call like any other voice call and the RABs are established accordingly.

A seamless local voice call facility at reduced overhead to operator (and reduced cost to subscriber) can thus be provided along with a single number and a single access device that can make calls to the CSG group people within the femto coverage occur as seamlessly as when they are out of coverage area, and without affecting other call related features associated with subscriber such as calls to and from other non-CSG, non-femto users; or to other non-CSG femto users.

Variations of the above can exist whereby, by mapping the IMSI/TMSI to MSISDN or MSISDN to CSG Id, the femto GW itself decides whether the call can be locally routed and indicate so to the MSC; this approach could require an additional field at the femto GW-MSC interface. In addition, the local software switching or bridging of RABs at the femto gateway can be used with other network devices such as convergence servers, media gateway controller/media gateway (MGC/MGW), or mobility anchor devices such as Home Agents, mobility management entities (MME), or another tunnel terminating device. In such network topologies, the local routing at the femto gateway removes the need to backhaul voice or data traffic between the femto gateway and the other network device. The removal of the backhaul link can reduce the amount of bandwidth needed between the femto gateway and the other network device.

Other embodiments are within the following claims. For example, the femto gateway could be combined with or co-located with a femto cell. In another example, the femto gateway could be combined with or co-located with an access gateway. Local routing at an access gateway is described in U.S. Patent Publication 2007/0253371, entitled “System and method for Traffic Localization,” which is hereby incorporated by reference herein in its entirety.

What is claimed:

1. A femto network for communicating with one or more mobile user equipment (UE) units when within a coverage area of one or more femto cells, the network comprising:
a femto gateway for communicating with one or more femto cells and with a mobile switching center, the femto gateway responsive to a determination that a called party and a calling party are served by the same femto gateway, the femto gateway being responsive to the determination for routing the call between the called party and the calling party without the call passing through the mobile switching center.

2. The network of claim 1, wherein the femto gateway receives from a mobile switching center information relating to a determination that a called party and a calling party are served by the same femto gateway.

3. The network of claim 2, further comprising a home location register for maintaining information on the location of UEs.

4. The network of claim 1 wherein the femto gateway receives from the femto cell a IMSI/TMSI.

5. The network of claim 1, wherein the femto gateway makes the determination that a called party and a calling party are served by the same femto gateway and provides information about the determination to the mobile switching center.

6. The network of claim 1, wherein the femto gateway communicates with a plurality of femto cells within a campus.

7. The network of claim 1, wherein the femto gateway communicates with a plurality of femto cells within a community.

8. A network for communicating with one or more mobile user equipment (UE) units when within a coverage area of one or more femto cells, the network comprising:
a mobile switching center for communicating with a femto gateway, the mobile switching center responsive to a call from a first UE to a second UE for determining that the first US and second UE are communicating through the same femto gateway, and for providing information to the femto gateway so that the femto gateway can route the call between the first UE and the second UE without the call passing through the mobile switching center.

9. A method for use in a femto network comprising:
a femto gateway communicating with users in femto cells and with a mobile switching center;
in response to a call from a calling party to a called party, determining that a called party and a calling party are served by the same femto gateway;
the femto gateway, responsive to the determination, for routing the call between the called party and the calling party without the call passing through the mobile switching center.

10. The method of claim 9, wherein the femto gateway receives from the mobile information indicating that a called party and a calling party are served by the same femto gateway.

11. The method of claim 9, wherein the femto gateway makes the determination that a called party and a calling party are served by the same femto gateway and provides information about the determination to the mobile switching center.
